(19) United States
(12) Patent Application Publication
(10) Pub. No.: US 2012/0123973 A1
(43) Pub. Date: May 17, 2012

(54) METHOD OF ASSIGNING A RELATIVE SEMINALITY SCORE TO INDIVIDUAL PATENTS WITHIN A PATENT LANDSCAPE

(76) Inventors: G. Edward Powell, JR., Nashville, TN (US); N. Edward White, Austin, TX (US); Mark T. Lane, Franklin, TN (US)

(21) Appl. No.: 12/947,147

(22) Filed: Nov. 16, 2010

(51) Int. Cl. G06Q 90/00

(52) U.S. Cl. 705/500

(57) ABSTRACT

A method for assigning a relative score to patents within a patent landscape is described, with the objective of being able to compare any two or more patents. A patent is considered seminal if the novelty of the invention is not a product of variations of prior art and spawns a new direction in intellectual property as described by new patents that come later. The method described in this document is one that combines a number of direct and indirect network factors and tempers the method by considering proximity to other patents within the landscape, incestuous citations, and other metric quantities inherent in the patent documents and from publicly available information. The method described is a relativistic model that is generic in that it does not depend on specific success of any individual patent to produce revenue or to fend off exposure to other specified intellectual property.

### BACKGROUND OF THE INVENTION

1. Field of the Invention

The present invention relates to the field of asset valuation and, in particular, to methods of relative valuation of patents within a patent landscape.

2. Description of the Related Art

Intellectual property represents a increasingly significant portion of the wealth and assets of the global community. Patents are an important component of intellectual property, and thus the ability to determine relative values and value ranges for patents has increasing utility.

Gathering information about individual patents is time consuming, complex, and requires careful analysis. It is impracticable to undertake such an endeavor for every patent within a large patent landscape. Instead, a fast and relativistic approach is needed that can identify valuable patents or patent families within classes, subclasses, markets, industries, groups, or entire patent landscapes, the objective being to rank patents in terms of their relative importance/seminality.

For the purposes of this invention, a patent is deemed to be seminal if the novelty of the invention is less a product of variation on related art and more a spawning of a new direction in intellectual property as described by subsequent patents. It is desirable to detect seminal patents as early as possible and to identify patents that are less seminal, as this capability is an important component of producing patent valuation models.

Seminal patents enable and motivate other inventors to build on the ideas outlined within the patent. If the same inventors are involved in all future inventions that cite a particular patent, then that patent is to be considered potentially less valuable than patents that are referenced by multiple different inventors. The method described in this document is one that combines a number of direct and indirect network factors and tempers the method by considering proximity to other patents within the landscape, incestuous citations, and other characteristics of the patent documents. It also utilizes other publicly available information. The objective is to determine a score that denotes the relative seminality of a patent or patents within a particular patent landscape.

### BRIEF SUMMARY OF THE INVENTION

Patent applications and granted patents typically contain citations to earlier granted patents and other works that describe related art. These citations form a citation tree representing a large network of both directly and indirectly related patents. Directly related patents are those that either directly cite or are directly cited by one another. Indirectly related patents are those where one or more intermediate patents help form a citation chain, for example patents #1 and #3, where patent #1 cites patent #2 which in turn cites patent #3. The present invention examines this citation tree in a number of ways, and optionally combines the results of the examination with a variety of other factors, to produce a score representing the relative seminality of a patent within its patent landscape.

Briefly, in a preferred embodiment, a count of direct citations to earlier granted patents is first tallied for each patent. Similarly, a count of direct references from later granted patents is also tallied for each patent. The number of direct references from later granted patents is then combined with the age of those references to produce an attractiveness value, which represents the likelihood of attracting additional references in the future. Given that indirect references can often be an important factor in determining relative seminality, a network value theoretic calculation is then used to augment the citation, reference, and attractiveness values.

Next, where either citations or references originate from patents owned by the same assignee, this incestuousness often impacts the seminality of those patents involved. Thus, an adjustment is made to the citation, reference and attractiveness values where incestuousness is found.

Finally, a number of patent attributes are examined, including assignee market capitalization, class/subclass membership, prosecution timing within class, prosecuting attorney, examiner, age since grant, word counts, prosecution duration, number of independent and dependent claims, and expiration date. These attributes are then evaluated to produce adjustment factors which are then combined with the citation, reference, and attractiveness values, resulting in an overall relative seminality value for each patent.

### BRIEF DESCRIPTION OF THE DRAWINGS

FIG. 1 presents a functional overview diagram of a preferred embodiment.

### DETAILED DESCRIPTION OF THE INVENTION

Patent applications and granted patents typically cite earlier granted patents and works that describe related art. These citations form a citation tree representing a large network of directly or indirectly related patents. Within this description we use the capital letter C to refer to patents that are cited by a particular patent, and the capital letter R to refer to patents that reference a particular patent. Later we introduce the notion of extending R and C based on indirect citations and references and other factors, but for the moment R=R₀ is just the count of references to the patent and C=C₀ is just the count of the citations made by the patent.

Every patent has the possibility of being referenced by subsequent patent applications. Within this description we use the capital letter A to denote, Attractiveness, a measure related to the likelihood of a patent to attract references by other patents (Modeling Innovation by a Kinetic Description of the Patent Citation System, Katherine J. Strandburg, 2007, 374 PHYSICA A 783).

If a patent does not receive any citations over time, it becomes less and less likely to do so. With each citation it receives, it becomes more likely to be cited again, particularly in the short term.

Overall, attractiveness decays with age, thus it is possible to use a Poisson Probability Distribution function to model this decay, which peaks some time from the patent grant date, and then exhibits a long tail of decay after the peak.

For example, one such function, loosely derived from the Poisson Probability Distribution function, that is fast and easy to calculate can be written as follows:

A=A(k, l)=Aₖ(k)Aₗ(l), (1)

where k is the number of citations a patent has received at a time t, 1 is the age of the patent as represented by the difference between the maximum patent number in the USPTO landscape granted on or before t and the patent number identifier in the USPTO, and the factor functions are described by:

Aₖ(k)=αk^{α}+α, (2)

with α=1.19 and α=1.11; and

Aₗ(l)=βe^{-y}, (3)

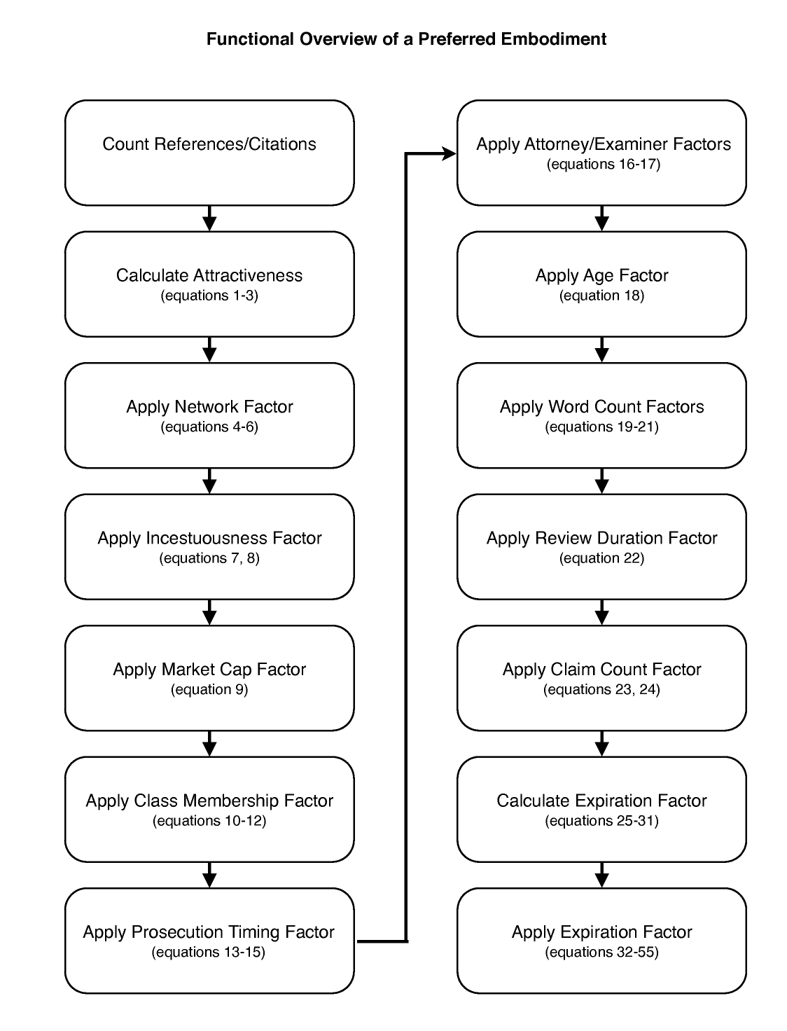

with y=1 if l=0, (l−μ).75μ if l<μ, and (l−μ)/2.5μ if l>μ. and β=2000 and μ=200,000. A view of this function for various values of number of citations, k, and age, l, is shown in FIG. 1.

However, the standard Attractiveness does not differentiate the value of various citations. Therefore, this method continues by traversing the citation tree using a network value theoretic approach. Consider a quantity that is denoted by inverse value, which is the simple count of the numbers of citations that directly reference the target patent. If a patent cites a patent that cites another patent, then we say that the first patent is an indirect citation of the base patent. At each level in the network tree, there is a network decay factor, DF, that modifies this count as one traverses the network tree. The decay factor should properly discount the amount of indirectness of the citation tree from each individual patent. Typically the decay factor DF should be a constant between 0 and 1, wherein values closer to 0 discount indirect citations more quickly and values closer to 1 discount them more slowly, weighting references with various degrees of separation more similarly. For example, in a preferred embodiment DF is set to 0.2 based on research on internet topologies (Linked: The New Science of Networks, Albert-László Barabási, 2002, Perseus, Cambridge, Mass.). The inverse value is the modification of R that takes into account indirect citations also. If we write Rₗₑᵥₑₗ to be the reference value at one level of the network citation tree, then we can write R as:

R=Σ_{(i=0, N)}DPⁱRₗₑᵥₑₗ(i), (4)

for N the maximum number of levels to traverse up the citation tree. Recall that R₀ is just the zero^{th} level of the reference citation tree count for the base patent, whereas Rₗₑᵥₑₗ for level >0 is really the sum of all of the R₀ counts for each patent that is part of the reference citation tree of the patent directly below it.

This process is repeated for a calculated value that is denoted the direct value, which starts with the patents that a patent cites and traverses the tree in the other direction, using citation values at each level that we denote Cₗₑᵥₑₗ. The direct value is the modification of C that takes into account indirect citations made by patents cited by a particular patent and so on:

C=Σ_{(i=0, N)}DPⁱCₗₑᵥₑₗ(i). (5)

Recall that C₀ is just the zero^{th} level of the direct citation tree counts from the base patent, whereas Cₗₑᵥₑₗ for level>0 is really the sum of all of the C₀ counts for each patent that is cited by the patent directly above it in the citation tree.

Finally, the same process is repeated for the function A=A(k, l) above, such that function values of the citing patents are summed (and not just raw counts), and this results in a quantity, Z, that is denoted as global attractiveness. We can compute Z₀=A for the base patent, and at each level we can use k as either the raw reference counts or k=integer part of the values for each patent participant in Rₗₑᵥₑₗ to calculate each A at that level and sum, to compute a value denoted Zₗₑᵥₑₗ. These can be all gathered together to calculate:

Z=Σ_{(i-0, N)}DFⁱZₗₑᵥₑₗ(i). (6)

Some owners of patents develop various strategies for incremental protection and continuous innovation through the use of divisional, continuations and adapting their patents for enhancements. When an assignee has a patent that references another patent assigned to that assignee, then this phenomenon is referred to here as an incestuous citation. If the only citations that a patent receives are those patents with the same assignee, then the method to determine a seminality factor may modify that when it applies the network theory. If, on the other hand, a patent is cited by the same assignee and by patents assigned to different assignees, then that means that the inventor or assignee is developing a more robust monopoly on a technology that is recognized by the outside world, and this is thought to indicate that the technology described and its associated IP rights are likely more valuable. Therefore, it is important to keep track of the patent assignees when analyzing citations.

Recall that for the inverse value, R, the network theory simply counts each connection as a single unit, and the value of each node of the citation tree is decreased by the network devaluation factor. In a preferred embodiment, the computations are enhanced as follows: when the assignees are the same for the patent being cited and the patent that does the citing, then if there are any other non-incestuous citations (that is there exists a patent with a different assignee that cites that patent), then that citation is counted twice, because the assignee is seen as increasing robustness in its monopoly on a particular technology that is being referenced. If there are not any other non-incestuous citations, then that citation is discounted for the owner's portfolio that only cites its own patents.

One of the more important parts of a preferred embodiment of the invention is that non-incestuous citations indicate 3^{rd} party validation of industry value and incestuous citations indicate robustness in patent family and families as a measure of internal strength. When there are many patents in a portfolio that cite each other it indicates strength and obstacles to design-around.

For example, as in a preferred embodiment, let each network level of the reference value R be expressed as follows:

Rₗₑᵥₑₗ=1.1^{sqrt(number of incestuous references)}[number of non-incestuous references], (7)

so that when there are not any non-incestuous references, the Rₗₑᵥₑₗ value for that network level is 0, and when there are not any incestuous references, then the Rₗₑᵥₑₗ value for that network level is just the number of non-incestuous references. When there is a mixture, the incestuous references can enhance the number of non-incestuous references. The citation count, k, used for that network level of the attractiveness, A, in equation (1) can be simply the integer part of the right-hand-side of equation (4) above.

Recall that for the citation value, C, the network theory simply counts each connection as a single unit, and the value of each node of the citation tree is decreased by the network devaluation multiplier. For example, in a preferred embodiment, let the direct citations in each network level of the direct value be driven by the number of non-incestuous citations and let the incestuous citations enhance that number:

Cₗₑᵥₑₗ=1.1^{sqrt(number of incestuous citations)}[number of non-incestuous citations]. (8)

For the global attractiveness function, Z, each of the network edges (in the inverse value calculation) in the citation tree are replaced by the value of the function A=A(k, l) in equation (1) above for the citing patent, as described above. The change to this calculation to accommodate incestuous citations will be exactly as for the inverse value calculation. In this case, when the count of the value of the citation is doubled, the double count can be used in the function Aₗₑᵥₑₗ=A(k, l) for the number of citations, k. If the assignees are the same and there are no other non-incestuous citations, then that citation is counted as 0, and if they are of different assignees then the count of the citations from patents that have the same assignees is one for each. When equation (1) is used, then one can use the integer part of R for k.

Within this description, we refer to possible alterations in the Rₗₑᵥₑₗ, Cₗₑᵥₑₗ, and Zₗₑᵥₑₗ values, and what we are referring to is that Rₗₑᵥₑₗ is the aggregate sum of Rₗₑᵥₑₗ values for each individual patent in the citation tree for that reference level, Cₗₑᵥₑₗ is the aggregate sum of Cₗₑᵥₑₗ values for each individual citation made by a patent in the citation tree for that citation level, and Zₗₑᵥₑₗ is the aggregate sum of Zₗₑᵥₑₗ values of attractiveness edges for each individual patent in the citation tree for that reference level. The attractiveness values for each patent that comprise the Zₗₑᵥₑₗ value is taken from equation (1), where a citation quantity k and an age, l, is used to estimate the ability for that patent to attract future citations. For the citation quantity, k, one can either use raw reference counts or the integer part of the component of Rₗₑᵥₑₗ that is comprised from that patent.

One can also alter the inverse value, R, according to the strength of citations from patents that belong to highly valued portfolios, as determined by the assignees of the citing patents. For example, in a preferred embodiment, if patents belong to a public company with a known market capitalization, then the weight of those citations at each network level when the market capitalization is high is increased using a factor CW (for capitalization weight). Specifically, the weight of a citation from an unknown assignee or from a public company with a market capitalization of below $10 Million is set to 1.0, the weight of a citation from a public company with market capitalization of between $10 Million and $100 Million is set to 2.0, between $100 Million and $1 Billion is set to 3, between $1 Billion and $10 Billion is set to 4, between $10 Billion and $100 Billion is et to 5, and greater than $100 Billion is set to 6:

Rₗₑᵥₑₗ=Rₗₑᵥₑₗ*CW and k=integer part of Rₗₑᵥₑₗ. (9)

One can also alter the inverse value, R, the citation value, C, the inputs to the attractiveness calculation, A, and the global attractiveness, Z, according to the strength of citations from the same classes or subclasses, which describe patents that have similar technologies. For example, in a preferred embodiment, if patents that are related to each other in the network citation tree all belong to similar technologies as described by the classes and subclasses, then that impacts the seminality score of the patent. A patent that cites a patent in the same class or subclass weakens the seminality score, whereas a patent that is cited by a patent in the same class or subclass strengthens the seminality score, because it shows that the patent is building strength within the class or subclass. Since citation values C weaken the seminality score, we can introduce a Group Factor Multiplier, denoted GFM, so that the count of references or citations are multiplied by GFM when they occur in the same class and subclass (or technology group) and 1.0 when they appear in different classes and subclasses (or technology group). A useful value to use for GFM is 2.0. This will change the values for Rₗₑᵥₑₗ and Cₗₑᵥₑₗ, and in the process alter the values for A and Zₗₑᵥₑₗ, so as to change the results for R, C, and Z through the network theory. Therefore, the calculation for Rₗₑᵥₑₗ and Cₗₑᵥₑₗ can be separated into two groups, those that belong to the same technology classes/subclasses (or groups) and those that don't, and we can write:

Rₗₑᵥₑₗ=Rₗₑᵥₑₗ(same groups)*GFM+Rₗₑᵥₑₗ(different groups), and k=integer part of Rₗₑᵥₑₗ (10)

and

Cₗₑᵥₑₗ=Cₗₑᵥₑₗ(same groups)*GFM+Cₗₑᵥₑₗ(different groups), and k=integer part of Cₗₑᵥₑₗ. (11)

Within this description, when we introduce individual factors, such as GFM, for two individual patents that are related together within the citation tree, rather than separate Rₗₑᵥₑₗ and Cₗₑᵥₑₗ into separate calculations, we will simply write:

Rₗₑᵥₑₗ=Rₗₑᵥₑₗ*GFM, Cₗₑᵥₑᵣ=Cₗₑᵥₑₗ*GFM, and k=integer part of Rₗₑᵥₑₗ, (12)

where it is assumed that the appropriate value for GFM is determined for each reference or citation in the citation tree.

One can also alter the inverse value, R, the citation value, C, the inputs to the attractiveness calculation, A, and the global attractiveness, Z, according to a determination of when patents in the citation tree are prosecuted relative to other patents within the same class and subclass. For example, in a preferred embodiment, patents that are prosecuted earlier within a given class and subclass are deemed more seminal than those prosecuted later. A reference factor multiple, RFM, and a citation factor multiple, CFM, is calculated according to a percentage ranking of all patents within a given class and subclass, such that reference values R, A, and Z get multiplied by RFM and citation value C gets multiplied by CFM:

RFM=1.0−the percentage ranking of prosecution, (13)

and

CFM=the percentage ranking of prosecution, (14)

so that:

Rₗₑᵥₑₗ=Rₗₑᵥₑₗ*RFM, and k=integer part of Rₗₑᵥₑₗ, and Cₗₑᵥₑₗ=Cₗₑᵥₑₗ*CFM (15)

For example, suppose that a patent, p, is cited by two referencing patents, r₁ and r₂, and suppose further that r₁ and r₂ appears in the same class, subclass grouping as the patent p, and that further suppose that r₁ is in the 20^{th} percentile according to prosecution and r₂ is in the 80^{th} percentile. Then we calculate RFM as 0.8 for r₁ and 0.2 for r₂, making the reference citation r₁ more valuable in the calculations for R than r₂. Suppose that a patent, p, cites two patents, c₁ and c₂, and suppose further that c₁ and c₂ appear in the same class, subclass grouping as the patent p, and that further suppose that c₁ is in the 20^{th} percentile according to prosecution and c₂ is in the 80^{th} percentile. Then we calculate CFM as 0.2 for c₁ and 0.8 for c₂, making the citation c₂ a bigger contributor to value decrement in the calculations for C than c₁.

One can also alter the inverse value, R, the citation value, C, the inputs to the attractiveness calculation, A, and the global attractiveness, Z, by considering patents that are written by the same attorney. Patents that are all written by a particular attorney may have similar language, numbers of words, numbers of independent and dependent claims, and may take advantage of the value and success of each either individually or taken as a group. For example, in a preferred embodiment, if patents that are related to each other in the network citation tree have been written by different attorneys or groups of attorneys, a factor of 1.0 is applied to the values used to calculate R, C, A, and Z. Where patents that are related to each other in the network citation tree were written by the same attorney, an Attorney Factor AF is applied. A value of 1.5 is used for AF. Thus:

Rₗₑᵥₑₗ=Rₗₑᵥₑₗ*AF, and k=integer part of Rₗₑᵥₑₗ, and Cₗₑᵥₑₗ=Cₗₑᵥₑₗ*AF (16)

One can also alter the inverse value, R, the citation value, C, the inputs to the attractiveness calculation, A, and the global attractiveness, Z, by considering patents that are examined by the same patent examiner. If patents that are related to each other in the network citation tree were examined by the same examiner, this impacts the seminality score of the patent. Patents that are examined by the same examiner may have a similar numbers of citations, have more or less detail in the claims specified, have a similar length of time span between filing date and grant date, and may take advantage of the value and success of each either individually or taken as a group. For example, in a preferred embodiment, a factor of 1.0 is applied to the values used to calculate R, C, A, and Z. Where patents that are related to each other in the network citation tree were approved by the same examiner, a factor EF is applied. A value of 1.5 is used for EF. Thus:

Rₗₑᵥₑₗ=Rₗₑᵥₑₗ*EF, and k=integer part of Rₗₑᵥₑₗ, and Cₗₑᵥₑₗ=Cₗₑᵥₑₗ*EF (17)

One can also alter the inverse value, R, the citation value, C, the inputs to the attractiveness calculation, A, and the global attractiveness, Z, by considering references that are closer in age to the patent being cited or the patents being cited. For example, in a preferred embodiment, when constructing a relative seminality value, patents that are closer in age to each other in the citation tree can be more relevant than patents that are distant from each other. It is desirable to detect seminality early, and citations that are close in age to a patent can be more important than those that come much later. Similarly, a patent that directly cites a nearby patent may be written with that patent in mind and may have more overlap in claims than otherwise. A good application of this idea is to bin the differences in ages of the patents related to each other in the citation tree. For the US patent landscape, patent IDs are numbers that are usually greater than 3 Million and always increasing as grant dates progress, and therefore in this case we can consider the difference of IDs to represent an age quantity (similar to the calculation of the age for the attractiveness value A above). If the age of related patents, either through citation C or reference R, are less than 200,000, for example, then this citation tree relationship is enhanced by an age bin factor ABF1, such as ABF1=3, between 200,001 and 500,000, by an age bin factor ABF2, such as ABF2=2, between 500,001 and 1,000,000, and by an age bin factor ABF3, such as ABF3=1.0. The age bin factor ABF is applied for all citation and reference relationships at each level of the network theory applications for enhancing R, C, and indirectly Z:

Rₗₑᵥₑₗ=Rₗₑᵥₑₗ*ABF, and k=integer part of Rₗₑᵥₑₗ, and Cₗₑᵥₑₗ=Cₗₑᵥₑₗ*ABF (18)

There are additional metric quantities that can be joined with the citation network quantities described above, such as length of time from filing to grant approval, number of independent and dependent claims, and length in words of the abstract and first independent claim, so as to compute a general “seminality value” for each patent. With word lengths, such as length of the abstract, length of the patent document, and length of independent or dependent claims, it is useful to bin the quantities rather than input the numbers of words directly into the computation of the seminality value. For example, in a preferred embodiment, one bin is used when the number of words in the first independent claim is 50 or less, the next bin for between 50 and 150 words, and the final for more than 150 words. When strength is inferred from a small number of words, one can use WF1 for the first bin of 50 words or less as 3.0, the next factor WF2 for the second bin between 50 and 150 words of 2.0, and the third factor for the third bin of 150 words or more as 1.0. The appropriate bin factor WF is then applied to each level of the network citation tree calculations for R and C, and indirectly A and Z:

Rₗₑᵥₑₗ=Rₗₑᵥₑₗ*WF, and k=integer part of Rₗₑᵥₑₗ, and Cₗₑᵥₑₗ=Cₗₑᵥₑₗ*WF, (19)

one can also use a similar binning process as the calculation of WF for the abstract length AF:

Rₗₑᵥₑₗ=Rₗₑᵥₑₗ*AF, and k=integer part of Rₗₑᵥₑₗ, and Cₗₑᵥₑₗ=Cₗₑᵥₑₗ*AF, (20)

and 10* WF for the binning process as a calculation of the total size (in words) for the patent document itself TWF:

Rₗₑᵥₑₗ=Rₗₑᵥₑₗ*TWF, and k=integer part of Rₗₑᵥₑₗ, and Cₗₑᵥₑₗ=Cₗₑᵥₑₗ*TWF. (21)

In a like manner, we can come up with a factor, denoted RLF, that takes into account the review length of time from filing to grant approval for a patent, such as RLF=3.0 if the review length is less than 2 years, 2.0 if the review length is between 2 and 3.5 years, 1.0 if the review length is between 3.5 and 5 years, and 0.75 if the review length is greater than 5 years:

Rₗₑᵥₑₗ=Rₗₑᵥₑₗ*RLF, and k=integer part of Rₗₑᵥₑₗ, and Cₗₑᵥₑₗ=Cₗₑᵥₑₗ* RLF (22)

In a like manner, we can come up with a factor, denoted NIF, that takes into account the number of independent claims, such as NIF=the number of independent claims (thinking that a larger number of independent claims can be more difficult to work around for new patents):

Rₗₑᵥₑₗ=Rₗₑᵥₑₗ*NIF, and k=integer part of Rₗₑᵥₑₗ, and Cₗₑᵥₑₗ=Cₗₑᵥₑₗ*NIF (23)

In a like manner, we can come up with a factor, denoted NDF, that takes into account the number of dependent claims, such as NDF=1.0 if there are between 0 and the number of independent claims, 1.5 if there are less than two times the number of independent claims, and 2.0 if there are more than two times the number of independent claims (thinking that a larger number of dependent claims related to the number of independent claims can be more difficult to work around for new patents):

Rₗₑᵥₑₗ=Rₗₑᵥₑₗ*NDF, and k=integer part of Rₗₑᵥₑₗ, and Cₗₑᵥₑₗ=Cₗₑᵥₑₗ*NDF. (24)

The first task in combining the metric quantities towards producing a seminality factor is to gather an “expiration factor”, f, for a patent, p. Patents have rules that govern their expiration, and if a patent holder does not pay their maintenance fees, then a patent can be prematurely expired. Once a patent expires, there is a six year decay period where the worth of a patent approaches zero. The rules changed for a patent's nominal expiration on Jun. 1, 1995. If the grant date of a patent is prior to that date, then the natural expiration is the grant date plus 17 years. Otherwise the natural expiration is the file date plus 20 years. But a patent can expire because of non-payment of maintenance fees, and a patent can be reinstated if those fees are caught up. If a patent expires, the clock starts ticking for 6 years before a patent is worth nothing, because a court can assign some value to patents after they have expired. The natural expiration date, x, based on the rules outlined above is calculated as follows. If the grant date is prior to Jun. 1, 1995, then

x=grant date+17 years; (25)

Otherwise

x=file date+20 years. (26)

If a patent has expired for non-payment of maintenance fees and has been reinstated, then the natural expiration date applies. Otherwise x becomes the date of the event where non-payment of maintenance fees has caused the patent to prematurely expire.

Now, consider a date in time, t, from which we wish to calculate the expiration factor, f. If x+6 years is less than t, then

f=0; (27)

If t<x, then

f=1; (28)

Otherwise, one can adjust the expiration factor according to an exponential fall-off rate:

f=e^{-1.2(t-x)}, (29)

where if the patent has expired naturally, then

f=0.5*f, (30)

and if the patent has expired for non-payment of maintenance fees, then the decay will be slower to allow for the patent holder to come in and reinstate the patent:

f=0.1*f. (31)

Now let f denote the patent expiration factor, as described above. The seminality value, v, is constructed as follows: Start with v=0. If the inverse value R is 0 (thus the patent has not received any references), then v is augmented as

v=v+0.1*A. (32)

If the inverse value R is less than 5.0, then v is augmented as

v=v+0.1*(R+1)*Z. (33)

Otherwise, v is augmented as

v=v+Z. (34)

Next v is augmented as 1000 times the inverse value R to reward those patents with citations:

v=v+1000*R. (35)

Next it is important to decrease the relative seminality value for those patents with a large direct value C>0, and one way to do this is using the following augmentation of v as follows:

v=v−(square root(C)*R). (36)

If after all of these arithmetic calculations cause the value metric v to be less than 100, then it is desirable to make v equal to 100 as a floor to give any patent that is living a nominal value:

If (v<100) then v=100. (37)

If the direct value C is greater than 0 and less than 5, then v is augmented by 1000:

v=v+1000; (38)

If the direct value C is greater than 5 and less than 10, then v is augmented by 800:

v=v+800; (39)

If the direct value C is greater than 10 and less than 15, then v is augmented by 500:

v=v+500; (40)

If the direct value C is greater than 15 and less than 20, then v is augmented by 300:

v=v+300; (41)

If the direct value C is greater than 20 and less than 25, then v is augmented by 100:

v=v+100; (42)

Next the length (in words) of the first independent claim is taken into account, with the objective of rewarding patents that have fewer words over those with many words, because it is believed that those patents with the first independent claim having fewer words are more seminal and valuable than those that are very verbose. To weed out bogus claims, the following rules are applied only to those patents with the first independent claim having a length of at least 5 words.

If the first independent claim has 20 or fewer words, then the value is increased by 1000:

v=v+1000; (43)

Otherwise if the first independent claim has 50 or fewer words, then the value is increased by 500:

v=v+500; (44)

Otherwise if the first independent claim has 80 or fewer words, then the value is increased by 100:

v=v+100; (45)

Next the length (in words) of the abstract is taken into account, with the objective of rewarding patents that have fewer words over those with many words, because it is believed that those patents with the abstract having fewer words are more seminal and valuable than those that are very verbose. Abstracts are limited to 150 words or less, but to weed out bogus claims, the following rules are applied only to those patents with the abstract having a length of at least 5 words.

If the abstract has 20 or fewer words, then the value is increased by 1000:

v=v+1000; (46)

Otherwise if abstract has 50 or fewer words, then the value is increased by 500:

v=v+500; (47)

Otherwise if the abstract has 100 or fewer words, then the value is increased by 100:

v=v+100; (48)

Next the review length (in days) from filing the patent to grant date is taken into account, with the objective of rewarding patents that take less time to grant.

If the review length is less than one year, then the value is increased by 1000:

v=v+1000; (49)

Otherwise if review length is less than two years, then the value is increased by 500:

v=v+500; (50)

Otherwise if review length is less than three years, then the value is increased by 100:

v=v+100; (51)

Next the length (in words) of the patent text is taken into account, with the objective of rewarding patents that have fewer words over those with many words, because it is believed that those patents with the patent text having fewer words are more seminal and valuable than those that are very verbose. The following rules are applied only to those patents with the patent text having a length of at least 150 words.

If the patent text has 1000 or fewer words, then the value is increased by 1000:

v=v+1000; (52)

Otherwise if the patent text has 2000 or fewer words, then the value is increased by 500:

v=v+500; (53)

Otherwise if the patent text has 3000 or fewer words, then the value is increased by 100:

v=v+100; (54)

Finally the calculated seminality value, v, is multiplied by the expiration factor, f, whose calculation is described above:

v=f*v. (55)

We claim:

1. A method of assigning a relative seminality score to individual patents within a patent landscape, comprising the steps of:
assigning a value C to each patent, representing the number of patents that are directly cited by said patent;
assigning a value R to each patent, representing the number of patents that directly cite said patent;
multiplying said value R for each patent, using a factor based upon the number of patents that both directly cite said patent and belong to the same assignee; and
combining said values C and R for each patent, producing a seminality score for each said patent.

2. A method of assigning a relative seminality score to individual patents within a patent landscape, comprising the steps of:
assigning a value C to each patent, representing the number of patents that are directly cited by said patent;
assigning a value R to each patent, representing the number of patents that directly cite said patent;
assigning each patent to one or more classes of subject matter to which they pertain;
multiplying said value R, using a factor based upon the number of citing patents that belong to differing assigned classes of subject matter; and
combining said values C and R for each patent, producing a seminality score for each said patent.

3. A method of assigning a relative seminality score to individual patents within a patent landscape, comprising the steps of:
assigning a value C to each patent, representing the number of patents that are directly cited by said patent;
assigning a value R to each patent, representing the number of patents that directly cite said patent;
assigning each said patent to one or more classes of subject matter to which they pertain;
multiplying said value R, using a factor based upon the percentage of patents prosecuted earlier than each patent within each assigned class of subject matter; and
combining said values C and R for each patent, producing a seminality score for each said patent.

4. A method of assigning a relative seminality score to individual patents within a patent landscape, comprising the steps of:
assigning a value C to each patent, representing the number of patents that are directly cited by said patent;
assigning a value R to each patent, representing the number of patents that directly cite said patent;
multiplying said value R, using a factor based upon the market capitalization of the assignees of said citing patents; and
combining said values C and R for each patent, producing a seminality score for each said patent.

5. A method of assigning a relative seminality score to individual patents within a patent landscape, comprising the steps of:
assigning a value C to each patent, representing the number of patents that are directly cited by said patent;
multiplying said value C for each patent, using a factor based upon the number of patents that are both cited by said patent and assigned to the same assignee;
assigning a value R to each patent, representing the number of patents that directly cite said patent; and
combining said values C and R for each patent, producing a seminality score for each said patent.

6. A method of assigning a relative seminality score to individual patents within a patent landscape, comprising the steps of:
assigning a value C to each patent, representing the number of patents that are directly cited by said patent;
assigning each said patent to one or more classes of subject matter to which they pertain;
multiplying said value C, using a factor based upon the percentage of patents prosecuted earlier than said patent, within each said class of subject matter;
assigning a value R to each patent, representing the number of patents that directly cite said patent; and
combining said values C and R for each patent, producing a seminality score for each said patent.

7. The method of any one of claims 1-6, further comprising the steps of:
assigning a value A to each patent, representing the likelihood that said patent will attract citations from future patent applications; and
combining said values C, R, and A for each patent, producing a seminality score for each said patent.

8. The method of any one of claims 1-6, further comprising the steps of:
augmenting said value C for each patent, by traversing the citation tree and counting the number of patents indirectly cited by said patent at each level in the tree, and then multiplying said count at each level by a network decay factor between 0 and 1 specific to said level, said network decay factor reflecting the distance in nodes between said level and said patent;
augmenting said value R for each patent, by traversing the citation tree and counting the number of patents indirectly citing said patent at each level in the tree, and then multiplying said count at each level by a network decay factor between 0 and 1 specific to said level, said network decay factor reflecting the distance in nodes between said level and said patent; and
combining said values C and R for each patent, producing a seminality score for each said patent.

9. The method of claim 7, further comprising the steps of:
augmenting said value C for each patent, by traversing the citation tree and counting the number of patents indirectly cited by said patent at each level in the tree, and then multiplying said count at each level by a network decay factor between 0 and 1 specific to said level, said network decay factor reflecting the distance in nodes between said level and said patent;
augmenting said value R for each patent, by traversing the citation tree and counting the number of patents indirectly citing said patent at each level in the tree, and then multiplying said count at each level by a network decay factor between 0 and 1 specific to said level, said network decay factor reflecting the distance in nodes between said level and said patent;
assigning a value Z to each patent, by traversing the citation tree and summing said value A from each patent indirectly citing said patent at each level in the tree, and multiplying said sum at each level by a network decay factor between 0 and 1 specific to said level, said network decay factor reflecting the distance in nodes between said level and said patent; and
combining said values Z, C, R, and A for each patent, producing a seminality score for each said patent.

10. The method of any one of claims 1-6, further comprising the step of:
multiplying said value R for each patent, using a factor based upon the age of each patent that directly cites each said patent.

11. The method of any one of claims 1-6, further comprising the step of:
multiplying said value C for each patent, using a factor based upon the age of each patent that is directly cited by each said patent.

12. The method of any one of claims 1-6, further comprising the step of:
determining if each patent has expired, and if so, multiplying said combined value for each patent in such a way as to reflect an exponential fall-off rate from the date of expiration, said fall-off rate to be more gradual in cases where expiration is the result of non-payment of maintenance fees.

13. The method of any one of claims 1-6, further comprising the step of:
multiplying said combined value for each patent using a factor determined by the length of its first independent claim.

14. The method of any one of claims 1-6, further comprising the step of:
multiplying said combined value for each patent using a factor determined by the elapsed time between filing and grant.

15. The method of any one of claims 1-6, further comprising the step of:
multiplying said combined value for each patent using a factor determined by the length of its abstract.

16. The method of any one of claims 1-6, further comprising the step of:
multiplying said combined value for each patent using a factor determined by its overall length.

17. The method of any one of claims 1-6, further comprising the step of:
multiplying said combined value for each patent using a factor determined by the number of its independent claims.

18. The method of any one of claims 1-6, further comprising the step of:
multiplying said combined value for each patent using a factor determined by the number of its dependent claims.

19. The method of any one of claims 1-6, further comprising the step of:
multiplying said combined value for each patent using a factor based upon the number of patents both cited by said patent and approved by a particular examiner.

20. The method of any one of claims 1-6, further comprising the step of:
multiplying said combined value for each patent using a factor based upon the number of patents both cited by said patent and prosecuted by a particular attorney.
